(19) United States
(12) Patent Application Publication
(10) Pub. No.: US 2018/0337861 A1
(43) Pub. Date: Nov. 22, 2018

(54) DYNAMIC SERVICE OPTIMIZATION OVER COMPUTING NETWORKS

(71) Applicants: Jaime LLORCA, Red Bank, NJ (US); Antonia Maria TULINO, Red Bank, NJ (US)

(72) Inventors: Jaime LLORCA, Red Bank, NJ (US); Antonia Maria TULINO, Red Bank, NJ (US)

(21) Appl. No.: 15/600,397

(22) Filed: May 19, 2017

(51) Int. Cl. H04L 12/851; H04L 12/54; H04L 12/861; H04L 12/841

(52) U.S. Cl. CPC H04L 47/2441; H04L 12/5691; H04L 47/32; H04L 49/9094; H04L 47/28; H04L 49/9057

(57) ABSTRACT

Various embodiments relate to a method and apparatus for performing dynamic computing network control where at each timeslot t, each node i is configured to observe a set of local queue backlogs where the local queue backlogs indicate the packet build-up of each commodity at node i and at its potential receivers (RXs), the method including steps of performing local transmission decisions, including computing, for each of commodity (d, m) and each receiving node j, a differential backlog weight, where d is a destination, m is a function, and j is an integer index indicating a specific receiving node, computing, for each transmission resource allocation choice, a metric value for each commodity, computing an optimal number of allocation resource units to allocate and an optimal commodity to transmit, transmitting the optimal commodity by allocating the allocation resource units when the metric value is greater than 0 and determining at least one of the potential RXs which will retain information associated with the transmitted optimal commodity.

### TECHNICAL FIELD

This disclosure relates generally to distributed computing networks which enable the deployment of digital services in the form of interconnected computing functions implemented over general purpose or dedicated hardware at multiple locations distributed throughout the network.

### BACKGROUND

In an augmented information (“AgI”) service, users consume information that results from the execution of a chain of service functions that process source information to create real-time augmented values. Applications may include real-time analysis of remote sensing data, real-time computer vision, personalized video streaming, and augmented reality, among others.

### SUMMARY OF EXEMPLARY EMBODIMENTS

A brief summary of various embodiments is presented below. Embodiments address the need to integrate and develop a method for existing network management systems to consolidate entries with textual identification with entries with numerical identification.

In order to overcome these and other shortcomings of the prior art and in light of the present need to develop a method for performing dynamic computing network control, a brief summary of various exemplary embodiments is presented. Some simplifications and omissions may be made in the following summary, which is intended to highlight and introduce some aspects of the various exemplary embodiments, but not to limit the scope of the invention.

Detailed descriptions of a preferred exemplary embodiment adequate to allow those of ordinary skill in the art to make and use the inventive concepts will follow in later sections.

Various embodiments described herein relate to a method for performing dynamic computing network control where at each timeslot t, each node i is configured to observe a set of local queue backlogs, where the local queue backlogs indicate the packet build-up of each commodity at node i and at its potential receivers (RXs), the method including performing local transmission decisions, including computing, for each of commodity (d, m) and each receiving node j, a differential backlog weight, where d is a destination, m is a function, and j is an integer index indicating a specific receiving node, computing, for each transmission resource allocation choice, a metric value for each commodity, computing an optimal number of allocation resource units to allocate and an optimal commodity to transmit, transmitting the optimal commodity by allocating the allocation resource units when the metric value is greater than 0, and determining at least one of the potential RXs which will retain information associated with the transmitted optimal commodity.

In an embodiment of the present disclosure, the method for performing dynamic computing network control, further includes keeping silent when the metric value is less than 0.

In an embodiment of the present disclosure, the differential backlog weight, Wᵢⱼ^{(d,m)}(t) is calculated by:

Wᵢⱼ^{(d,m)}(t) [symbol] [Qᵢ^{(d,m)}(t)−Qⱼ^{(d,m)}(t)]⁺.

The method for performing dynamic computing network control of claim 1, wherein the metric for each commodity is calculated by:

$${W}_{i , k , tr}^{( d , m )} ( t ) {\sum }_{s ∈ S}^{ } Pr ( S ( t ) = s \vert S ( t - 1 ) = \tilde{s} ) \times {\sum }_{n = 1}^{N - 1} [ {R}_{{ig}_{i , n} , k} ( s ) - {R}_{{ig}_{i , n - 1} , k} ( s ) ] {max}_{j ∈ {Ω}_{i , n} ( s )} \{ {W}_{ij}^{( d , m )} ( t ) \}$$

wherein \tilde{s} denotes channel state information (“CSI”) feedback at time t−1, and Ω_{i,n}(s) indicates the dependence of Ω_{i,n} on network state s.

In an embodiment of the present disclosure, the optimal number of allocated transmission resource units, kₜᵣ^{†} to allocate and an optimal commodity, (d, m)ₜᵣ^{†} to transmit are calculated by:

$$[ {k}_{tr}^{†} , {( d , m )}_{tr}^{†} ] = arg {max}_{k , ( d , m )} \{ {W}_{i , k , tr}^{( d , m )} ( t ) - {Vw}_{i , k}^{tr} \} .$$

In an embodiment of the present disclosure, the metric value is denoted by Wᵢ^{tr†}(t).

In an embodiment of the present disclosure, the determining at least one of the potential RXs which will retain information associated with the transmitted optimal commodity is based on choosing the RX with largest positive weight W^{(d,m)}^{ₜᵣ}^{^{†}}ᵢⱼ(t).

In an embodiment of the present disclosure, the method for performing dynamic computing network control of, further includes performing local processing decisions, including computing, for each commodity (d, m), processing utility weights, computing an optimal number of allocation resource units and an optimal commodity to process and determining flow rate assignment decisions.

In an embodiment of the present disclosure, the processing utility weights are computed by:

$${W}_{i}^{( d , m )} ( t ) {=}^{Δ} \frac{1}{{r}^{( m + 1 )}} [ {Q}_{i}^{( d , m )} ( t ) - {ξ}^{( m} {{Q}_{i}^{( d , m + 1 )} ( t )}^{+} .$$

In an embodiment of the present disclosure, the optimal number of allocated processing resource units and the optimal commodity to process is computed by:

$$[ {k}_{pr}^{†} , {( d , m )}_{pr}^{†} ] = arg {max}_{k , ( d , m )} \{ {R}_{i , k} {W}_{i}^{( d , m )} ( t ) - {Vw}_{i , k}^{pr} \} .$$

In an embodiment of the present disclosure, the flow rate assignment decisions are determined by:

$${μ}_{i , pr}^{{( d , m )}_{pr}^{†}} ( t ) = {R}_{i , {k}_{pr}^{†}} {r}^{( {m}_{pr}^{†} + 1 )} ;$$

$${μ}_{i , pr}^{( d , m )} ( t ) = 0 , ∀ ( d , m ) \neq {( d , m )}_{pr}^{†} .$$

Various embodiments described herein relate to a non-transitory machine-readable storage medium encoded with instructions executable to perform a method by a processor for performing dynamic computing network control where at each timeslot t, each node i is configured to observe a set of local queue backlogs, where the local queue backlogs indicate the packet build-up of each commodity at node i and at its potential RXs, the machine-readable storage medium including instructions for performing local transmission decisions, including computing, for each of commodity (d, m) and each receiving node j, a differential backlog weight, where d is a destination, m is a function, and j is an integer index indicating a specific receiving node, computing, for each transmission resource allocation choice, a metric value for each commodity, computing an optimal number of allocation resource units to allocate and an optimal commodity to transmit; and transmitting the optimal commodity by allocating the allocation resource units when the metric value is greater than 0 and determining at least one of the potential RXs which will retain information associated with the transmitted optimal commodity.

In an embodiment of the present disclosure, the non-transitory machine-readable storage medium of claim 11, further including keeping silent when the metric value is less than 0.

In an embodiment of the present disclosure, the differential backlog weight, Wᵢⱼ^{(d,m)}(t) is calculated by:

Wᵢⱼ^{(d,m)}(t) [symbol] [Qᵢ^{(d,m)}(t)−Qⱼ^{(d,m)}(t)]⁺.

In an embodiment of the present disclosure, the metric for each commodity is calculated by:

$${W}_{i , k , tr}^{( d , m )} ( t ) {=}^{Δ} {\sum }_{s ∈ S} Pr ( S ( t ) = s \vert S ( t - 1 ) = \tilde{s} ) \times {\sum }_{n = 1}^{N - 1} [ {R}_{{ig}_{i , n} , k} ( s ) - {R}_{{ig}_{i , n - 1} , k} ( s ) ] {max}_{j ∈ {Ω}_{i , n} ( s )} \{ {W}_{ij}^{( d , m )} ( t ) \} ,$$

wherein \tilde{s} denotes CSI feedback at time t−1 and Ω_{i,n}(s) indicates the dependence of Ω_{i,n} on network state s.

In an embodiment of the present disclosure, the optimal number of resource units, kₜᵣ^{†} to allocate and an optimal commodity, (d, m)ₜᵣ^{†} to transmit are calculated by:

$$[ {k}_{tr}^{†} , {( d , m )}_{tr}^{†} ] = arg {max}_{k , ( d , m )} \{ {W}_{i , k , tr}^{( d , m )} ( t ) - {Vw}_{i , k}^{tr} \} .$$

In an embodiment of the present disclosure the metric value is denoted by Wᵢ^{tr†}(t).

In an embodiment of the present disclosure, the determining at least one of the potential RXs which will retain information associated with the transmitted optimal commodity is based on choosing the RX with largest positive weight W^{(d,m)}^{ₜᵣ}^{^{†}}ᵢⱼ(t).

In an embodiment of the present disclosure, the non-transitory machine-readable storage medium, further including performing local processing decisions, including computing, for each commodity (d, m), processing utility weights, computing an optimal number of allocation resource units and an optimal commodity to process and determining flow rate assignment decisions.

In an embodiment of the present disclosure, the processing utility weights are computed by:

$${W}_{i}^{( d , m )} ( t ) {=}^{Δ} \frac{1}{{r}^{( m + 1 )}} [ {Q}_{i}^{( d , m )} ( t ) - {ξ}^{( m + 1} {{Q}_{i}^{( d , m + 1 )} ( t )}^{+} .$$

In an embodiment of the present disclosure, the optimal number of allocation resource units and the optimal commodity to process is computed by:

$$[ {k}_{pr}^{†} , {( d , m )}_{pr}^{†} ] = arg {max}_{k , ( d , m )} \{ {R}_{i , k} {W}_{i}^{( d , m )} ( t ) - {Vw}_{i , k}^{pr} \} .$$

In an embodiment of the present disclosure, the flow rate assignment decisions are determined by:

$${μ}_{i , pr}^{{( d , m )}_{pr}^{†}} ( t ) = {R}_{i , {k}_{pr}^{†}} {r}^{( {m}_{pr}^{†} + 1 )} ;$$

$${μ}_{i , pr}^{( d , m )} ( t ) = 0 , ∀ ( d , m ) \neq {( d , m )}_{pr}^{†} .$$

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

These and other more detailed and specific features are more fully disclosed in the following specification, reference being had to the accompanying drawings, in which:

FIG. 1 illustrates an AgI service chain for destination d∈ [symbol] .

FIG. 2 illustrates a timing diagram of a communication protocol over a link for a single timeslot.

FIG. 3 illustrates a flowchart for a method of performing dynamic computing network control.

### DETAILED DESCRIPTION OF THE INVENTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Descriptors such as “first,” “second,” “third,” etc., are not meant to limit the order of elements discussed, are used to distinguish one element from the next, and are generally interchangeable.

The disclosure addresses the problem of optimal distribution of AgI services over a wireless computing network, in which nodes are equipped with both communication and computing resources.

The wireless computing network capacity region includes joint flow scheduling and resource allocation algorithm that stabilize the underlying queuing system while achieving arbitrarily close to minimum network cost, with a tradeoff in network delay.

However, this disclosure utilizes the unique chaining and flow scaling aspects of AgI services, while exploiting the use of the broadcast approach over the wireless channel to achieve close to minimum network cost, with a tradeoff in network delay.

Internet traffic may become dominated by AgI services and unlike traditional information services, in which users consume information that is produced or stored at a given source and is delivered via a communications network, AgI services provide end users with information that results from the processing of source information via multiple service functions that can be hosted anywhere in the network.

For example, real-time analysis of remote sensing data, real-time computer vision, personalized video streaming, and augmented reality services.

AgI services are implemented in the form of virtual functions instantiated over general purpose servers at centralized cloud data centers and the low latency requirements of real-time AgI services drive cloud resources closer to the end users in the form of small cloud nodes at the edge of the network, resulting in a distributed cloud network.

AgI services may be sourced and accessed from wireless devices and service functions may be hosted at wireless computing nodes (i.e., computing devices with wireless networking capabilities).

When introducing the wireless network into the computing infrastructure, the unpredictable nature of the wireless channel further complicates flow scheduling, routing, and resource allocation.

The Lyapunov drift plus penalty (“LPP”) control methodology is designed to handle network optimization problems. The LPP approach to multi-hop, multi-commodity wireless ad-hoc networks, leads to the Diversity Backpressure (“DIVBAR”) algorithm.

The DIVBAR algorithm exploits the broadcast nature of the wireless channel without the need of instantaneous channel state information (“CSI”) and it is considered to be optimal assuming that at most one packet can be transmitted in each transmission attempt and that no advanced coding scheme is used.

This method is directed towards a method and apparatus for optimal distribution of AgI services over a multi-hop wireless computing network.

The multi-hop wireless computing network may be composed of nodes with communication and computing capabilities. The multi-commodity-chain flow model for the delivery of AgI services may be extended over wireless multi-hop computing networks, enabling the characterization of the unique flow chaining and scaling aspects of AgI services.

The broadcast approach is utilized where information is encoded into superposition layers according to the channel conditions, in order to exploit routing diversity with enhanced transmission efficiency.

This method allows characterizing the capacity region of a wireless computing network and designing a fully distributed flow scheduling and resource allocation algorithm that adaptively stabilizes the underlying queuing system while achieving close to minimum network cost, with a tradeoff in network delay.

For example, a wireless computing network composed of N=|N| distributed computing nodes that may communicate over wireless links labeled according to node pairs (i, j) for i, j∈N. Node i∈N is equipped with Kᵢ^{tr} transmission resource units (e.g., transmit power) that is used to transmit information over the wireless channel. In addition, node i is equipped with Kᵢ^{pr} processing resource units (e.g., central processing units or CPUs) used to process information as part of an AgI service.

Time is slotted with slots normalized to integer units t∈{0,1,2, . . . }. The binary variable [symbol] _{i,k}^{tr}(t)∈{0,1} is used to indicate the allocation or activation of k∈{0, . . . ,Kᵢ^{pr}} transmission resource units at node i at time t, which incurs w_{i,k}^{pr} cost units.

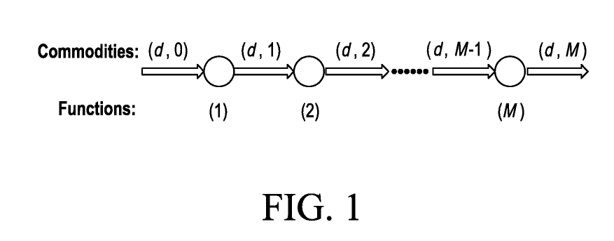

FIG. 1 illustrates a multi-commodity-chain flow model, in which commodity (d, m)∈ [symbol] ×{□, 0} identifies the flow of information units (of arbitrarily fine granularity, e.g., bits) output of function m∈ [symbol] for destination d∈ [symbol] , where the distribution of an augmented information service described by a chain of functions □={1,2, . . . ,M} for a subset of destination nodes is D⊂N.

Commodity (d, 0) denotes the source commodity for destination d, which identifies the flow of information units that arrive exogenously at the origin nodes [symbol] ⊂N for destination d.

Each service function has different processing requirements. For example, r^{(m)} denotes the number of operations per information unit performed by function m.

Another key aspect of AgI services is the fact that information flows can change size as the AgI services go through service functions and as r^{(m)}>0 denotes the scaling factor of function m, the size of the function's output flow is (m) times as large as its input flow.

Moreover, a processing delay Dᵢ^{(m)} (in timeslots) is incurred in executing function m at node i, as long as the processing flow satisfies the node's processing rate constraint.

Due to the broadcast nature of the wireless medium, multiple receivers (“RXs”) may overhear the transmission of a given transmitter (“TX”). Multiple TXs may transmit simultaneously to overlapping RXs, due to the use of orthogonal broadcast channels of fixed bandwidth.

The channel between node i and all other nodes in the network is modeled as a physically degraded Gaussian broadcast channel where the network state process (the vector of all channel gains), denoted by S(t)≡{sᵢⱼ(t), ∀i, j∈N}, evolves according to a Markov process with state set [symbol] and whose steady-state probability exists.

The TX can only learn the CSI realizations after the transmission has taken place and is thereby delayed, while the statistical CSI is known at each time-slot.

Superposition coding is optimal (capacity achieving) for the physically degraded broadcast channel with independent messages.

The adopted broadcast approach includes sending incremental information using superposition layers, such that the number of decoded layers at any RX depends on its own channel state and the information decoded by a given RX which is a subset of the information decoded by any other RX with no worse channel gain.

For example, for a given transmitting node i, if the N−1 potential receiving nodes are sorted in non-decreasing order of their channel gains {gᵢ, ₁, . . . , gᵢ, N₋₁}, such that g_{i,n} with n∈{1, . . . , N−1} denotes the receiver with the n-th lowest channel gain, then the information decoded by receiver g_{i,n} is also decoded by receiver g_{i,l} for l>n.

Further, if Ωᵢ [symbol] {g_{i,n}, . . . ,gᵢ,N₋₁} is the set of receivers with the N−n highest channel gains, then we can partition the information transmitted by node i during a given timeslot into N−1 disjoint groups, with the n-th partition being the information decoded by every node in Ω_{i,n} and not by any node in Ω_{i,l} with l<n.

Further, if γ_{i,k}(α) denotes the optimal power density function over the continuum of superposition layers resulting from the allocation of k transmission resource units at node i., then, based on the broadcast approach, the maximum achievable rate on link (i,j) at time t is given by Equation 1.

$${R}_{ij , k} ( t ) = {\int }_{0}^{{s}_{ij} ( t )} \frac{a {\tilde{γ}}_{i , k} ( a )}{1 + a {\int }_{a}^{∞} {\tilde{γ}}_{i , k} ( s ) ds} da . \qquad Equation 1$$

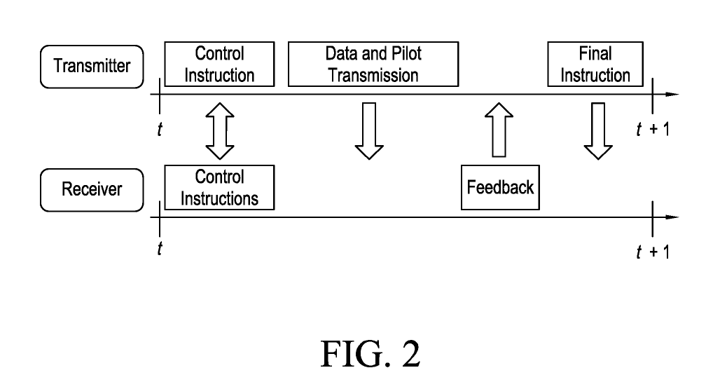

FIG. 2 illustrates the communication protocol between each TX-RX pair within a single timeslot. At the beginning of each timeslot, TX and RX exchange necessary control signals. Then, the TX decides how many transmission resource units to allocate for the given timeslot and how to allocate the given bandwidth among the commodities for transmission. Then, the transmission starts and lasts for a fixed time period (within the timeslot) and during that time both data and pilot tones (whose overhead is neglected) are transmitted. After the transmission ends, every potential RX provides immediate feedback, which may include decoded information and/or experienced CSI. The TX then makes a forwarding decision that determines the information units for which each RX gets forwarding responsibility and sends the decision as a final instruction to all the RXs. Only the RX that gets the forwarding responsibility keeps the corresponding information units, while others discard their copies.

μ^{(d,m)}(t) denotes the information units of commodity (d,m) retained by node j after the transmission from node i during timeslot t.

Σ_{(d,m)}μᵢⱼ^{(d,m)}(t)≤Σₖ₌₀^{K}^{ᵢ}^{^{tr}}R_{ij,k}(t)y_{i,k}^{tr}(t), ∀i,j Equation 2

where R_{ij,k}(t) is given by Equation 1.

Information kept by node g_{i,l} from the n-th partition of node i's transmitted information at time t is denoted by μ_{ig}_{_{i,l}}_{,n}^{(d,m)}(t).

$$\begin{matrix} {μ}_{{ig}_{i , l}}^{( d , m )} ( t ) = {\sum }_{n = 1}^{l} {μ}_{{ig}_{i , l} , n}^{( d , m )} ( t ) , ∀ i , l , d , m , t , & Equation 3 \\ {\sum }_{( d , m )} {\sum }_{l = n}^{N - 1} {μ}_{{ig}_{i , l} , n}^{( d , m )} ( t ) \leq {\sum }_{k = 0}^{{K}_{i}^{tr}} [ {R}_{{ig}_{i , n} , k} ( t ) - {R}_{{ig}_{i , n - 1} , k} ( t ) ] {y}_{i , k}^{tr} ( t ) , \\ ∀ i , l , n , t , & Equation 4\end{matrix}$$

In Equation 3, R_{ig}_{_{i,0}}_{,k}(t)=0, ∀i, k, t.

Equation 4 is consistent with the fact that only one copy of the transmitted information units is kept for forwarding purposes.

For example, if a static dedicated computing channel model, where the achievable processing rate at node i with the allocation of k processing resource units is given by R_{i,k}, then μ_{i,pr}^{(d,m)}(t) may be used to denote the assigned flow rate from node i to its processing unit for commodity (d, m) at time t, and μ_{pr,i}^{(d,m)}(t) for the flow rate from the processing unit back to node.

$$\begin{matrix}{μ}_{pr , i}^{( d , m )} ( t ) = {ξ}^{( m )} {μ}_{i , pr}^{( d , m - 1 )} ( t - {D}_{i}^{( m )} ) , ∀ i , d , m 1 & Equation 5 \\ {\sum }_{( d , m > 0 )} ( {μ}_{i , pr}^{d , m - 1} ) ( t ) {r}^{( m )} \leq {\sum }_{k = 0}^{{K}_{i}^{pr}} {R}_{i , k} {y}_{i , k}^{pr} ( t ) , ∀ i , t , & Equation 6\end{matrix}$$

Equations 5 and Equation 6 are multi-commodity-chain and maximum rate constraints, respectively.

The exogenous arrival rate of commodity (d, m)∈ [symbol] ×{ [symbol] ,0} at node i during timeslot t is denoted by aᵢ^{(d,m)}(t) and by λᵢ^{(d,m)} which is its expected value.

aᵢ^{(d,m)}(t) is independently and identically distributed across timeslots and its second moment is upper bounded by constant Aₘₐₓ².

In an AgI service, only the source commodity (d, 0) enters the network exogenously, while all other commodities are created inside the network as the output of a service function.

Therefore, aᵢ^{(d,m)}(t)=0, for all t when m>0 or i∉ [symbol] .

During network evolution, internal network queues buffer the data according to their commodities. The queue backlog of commodity (d, m) at node i, Qᵢ^{(d,m)}(t) is defined as the amount of commodity (d, m) in the queue of node i at the beginning of timeslot t, which evolves over time.

Qᵢ^{(d,m)}(t+1)≤[Qᵢ^{(d,m)}(t)−Σ_{j:j≠i}μᵢⱼ^{(d,m)}(t)−μ_{i,pr}^{(d,m)}(t)]⁺+Σ_{j:j≠i}μⱼᵢ^{(d,m)}(t)+μ_{pr,i}^{(d,m)}(t)+aᵢ^{(d,m)}(t) Equation 7

In an AgI service, only the final commodity (d, M) is allowed to exit the network once it arrives to its destination d∈D, while any other commodity (d, m), m<M, can only get consumed by being processed into the next commodity (d, m+1) in the service chain. Final commodity (d, M) leaves the network immediately upon arrival/decoding, (i.e., Q_{d}^{(d,M)}=0, for all d, t).

The control algorithm dynamically distributes the service and schedules the flow in the network to minimize the average resource cost.

$$t \to ∞ lim sup \frac{1}{t} {\sum }_{τ = 0}^{t - 1} 𝔼 \{ h ( τ ) \} , \qquad Equation 8$$

h(τ) is the total cost of the network at time τ.

$$h ( τ ) {=}^{Δ} {\sum }_{i ∈ N} [ {\sum }_{k = 0}^{{K}_{i}^{pr}} {w}_{i , k}^{pr} {y}_{i , k}^{pr} ( τ ) + {\sum }_{k = 0}^{{K}_{i}^{tr}} {w}_{i , k}^{tr} {y}_{i , k}^{tr} ( τ ) ] , \qquad Equation 9$$

while ensuring the network is rate stable (see Equation 4).

$${lim}_{t \to ∞} \frac{1}{t} {Q}_{i}^{( d , m )} ( t ) = 0 with prob . 1 , ∀ i , d , m . \qquad Equation 10$$

A dynamic wireless computing network control strategy that accounts for both transmission and processing-related flow and resource allocation decisions in a fully distributed manner allows for defining a non-negative control parameter V representing the degree to which resource cost minimization is emphasized.

Dynamic Wireless Computing Network Control (“DWCNC”) includes local wireless transmission decisions and local processing decisions.

For Local wireless transmission decisions, at timeslot t, each node i observes its local queue backlogs, the queue backlogs of its potential RXs and the associated statistical CSI, and computes, for each commodity (d, m) and each receiving node j, the differential backlog weight:

Wᵢⱼ^{(d,m)}(t)=^{Δ}[Qᵢ^{(d,m)}(t)−Qⱼ^{(d,m)}(t)]⁺.

Then, for each transmission resource allocation choice k∈{0, . . . , Kᵢ^{tr}}, the metric value for each commodity (d, m) is computed:

$${W}_{i , k , tr}^{( d , m )} ( t ) {=}^{Δ} {\sum }_{s ∈ S} Pr ( S ( t ) = s \vert S ( t - 1 ) = \tilde{s} ) \times {\sum }_{n = 1}^{N - 1} [ {R}_{{ig}_{i , n} k} ( s ) - {R}_{{ig}_{i , n - 1} , k} ( s ) ] {max}_{j ∈ {Ω}_{i , n} ( s )} \{ {W}_{ij}^{( d , m )} ( t ) \} ,$$

where \tilde{s} denotes the CSI feedbacks at time t−1, and, an abuse of notation, Ω_{i,n}(s) is used to indicate the dependence of Ω_{i,n} on the the network state.

Then, the optimal number of resource units kₜᵣ^{†} to allocate and the optimal commodity (d, m)ₜᵣ^{†} to transmit is computed:

$$[ {k}_{tr}^{†} , {( d , m )}_{tr}^{†} ] = arg {max}_{k , ( d , m )} \{ {W}_{i , k , tr}^{( d , m )} ( t ) - {Vw}_{i , k}^{tr} \} ,$$

where Wᵢ^{tr†}(t) is the corresponding metric value.

Then, if Wᵢ^{tr†}(t)>0, node i transmits commodity (d, m)ₜ^{†} by allocating kₜᵣ^{†} transmission resource units; otherwise, node i keeps silent (kₜᵣ^{†}=0) at time t.

After receiving the CSI feedbacks, node i derives the information decoded by each RX and assigns the forwarding responsibility for the n-th partition of the transmitted information to the RX in Ω_{i,n}(S(t)) with the largest positive Wᵢⱼ^{(d,m)}(t), while all other RXs in Ω_{i,n}(S(t)) and node i discard the information.

If no receiver in Ω_{i,n}(S(t)) has positive Wᵢⱼ^{(d,m)}(t), node i retains the information of partition n, while all the receivers in Ω_{i,n}(S(t)) discard it.

In an abuse of notation, Ω_{i,n}(S(t)) is used to indicate the dependence of Ω_{i,n} on the realization of the network state at time t.

For local processing decisions, at timeslot t, each node i observes its local queue backlogs and computes the processing utility weights for each commodity (d, m):

$${W}_{i}^{( d , m )} ( t ) {=}^{Δ} {\frac{1}{{r}^{( m + 1 )}} [ {Q}_{i}^{( d , m )} ( t ) - {ξ}^{( m + 1 )} {Q}_{i}^{( d , m + 1 )} ( t ) ]}^{+}$$

W_{I}^{(d,m)}(t) indicates the benefit of executing function (m+1) to process commodity (d, m) into commodity (d, m+1) at time t, in terms of the local backlog reduction per processing unit cost.

Then, the optimal number of resource units kₚᵣ^{†} to allocate and the optimal commodity (d, m)ₚᵣ^{†} to process is computed:

$$[ {k}_{pr}^{†} , {( d , m )}_{pr}^{†} ] = arg {max}_{k , ( d , m )} \{ {R}_{i , k} {W}_{i}^{( d , m )} ( t ) - {Vw}_{i , k}^{pr} \}$$

Then, the flow rate assignment decisions are made by:

$${μ}_{i , pr}^{{( d , m )}_{pr}^{†}} ( t ) = {R}_{i , {k}_{pr}^{†}} {r}^{( {m}_{pr}^{†} + 1 )} ; {μ}_{i , pr}^{( d , m )} ( t ) = 0 , \\ ∀ ( d , m ) \neq {( d , m )}_{pr}^{†}$$

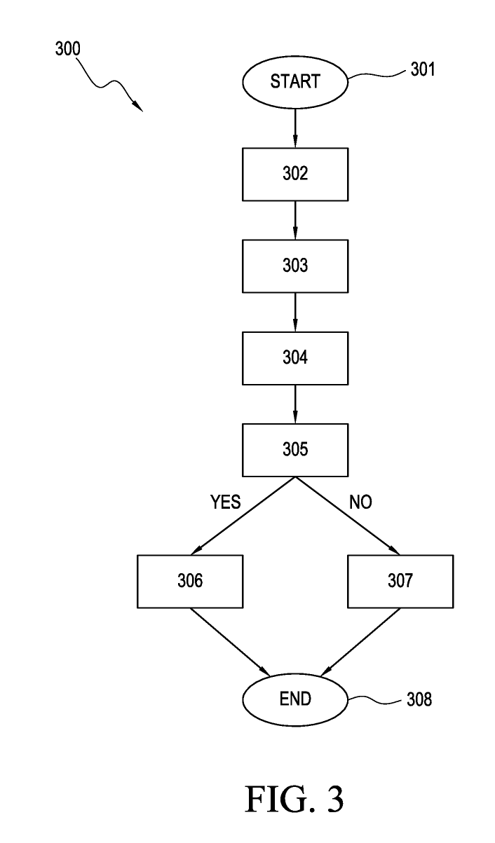

FIG. 3 illustrates a method for performing dynamic computing network control. The method 300 for performing dynamic wireless computing network control begins at step 301 and continues to step 302 which computes, for each of commodity (d, m) and each receiving node j, a differential backlog weight.

The method 300 then proceeds to step 303 which computes, for each transmission resource allocation choice, a metric value for each commodity.

The method 300 then proceeds to step 304 which computes, an optimal number of allocation resource units to allocate and an optimal commodity to transmit.

The method 300 then proceed to step 305 which determines whether the metric value is greater than 0. If yes, the metric value is greater than 0, the method 300 proceeds to step 306 which transmits the optimal commodity by allocating the allocation resource units. If no, the metric value is less than 0, the method 300 proceeds to step 307 which keeps the node silent.

The method 300 then ends at step 308.

Optimal distribution of augmented information services over wireless computing networks is solved by unique chaining and flow scaling aspects of AgI services, while exploiting the use of the broadcast approach over the wireless channel.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for performing dynamic computing network control where at each timeslot t, each node i is configured to observe a set of local queue backlogs, where the local queue backlogs indicate the packet build-up of each commodity at node i and at its potential receivers (RXs), the method comprising steps of:
performing local transmission decisions, comprising:
computing, for each of commodity (d, m) and each receiving node j, a differential backlog weight, where d is a destination, m is a function, and j is an integer index indicating a specific receiving node;
computing, for each transmission resource allocation choice, a metric value for each commodity;
computing an optimal number of allocation resource units to allocate and an optimal commodity to transmit;
transmitting the optimal commodity by allocating the allocation resource units when the metric value is greater than 0, and
determining at least one of the potential RXs which will retain information associated with the transmitted optimal commodity.

2. The method for performing dynamic computing network control of claim 1, further comprising:
keeping silent when the metric value is less than 0.

3. The method for performing dynamic computing network control of claim 1, wherein the differential backlog weight, Wᵢⱼ^{(d,m)}(t) is calculated by:
Wᵢⱼ^{(d,m)}(t) [symbol] [Qᵢ^{(d,m)}(t)−Qⱼ^{(d,m)}(t)]⁺.

4. The method for performing dynamic computing network control of claim 1, wherein the metric for each commodity is calculated by:
$${W}_{i , k , tr}^{( d , m )} ( t ) {=}^{Δ} {\sum }_{s ∈ S} Pr ( S ( t ) = s \vert S ( t - 1 ) = \tilde{s} ) \times {\sum }_{n = 1}^{N - 1} [ {R}_{{ig}_{i , n} , k} ( s ) - {R}_{{ig}_{i , n - 1} , k} ( s ) ] {max}_{j ∈ {Ω}_{i , n} ( s )} \{ {W}_{ij}^{( d , m )} ( t ) \}$$
wherein \tilde{s} denotes channel state information (“CSI”) feedback at time t−1, and Ω_{i,n}(s) indicates the dependence of Ω_{i,n} on network state s.

5. The method for performing dynamic computing network control of claim 1, wherein the optimal number of allocated transmission resource units, kₜᵣ^{†} to allocate and an optimal commodity, (d, m)ₜᵣ^{†} to transmit are calculated by:
$$[ {k}_{tr}^{†} , {( d , m )}_{tr}^{†} ] = arg {max}_{k , ( d , m )} \{ {W}_{i , k , tr}^{( d , m )} ( t ) - {Vw}_{i , k}^{tr} \} .$$

6. The method for performing dynamic computing network control of claim 1, wherein the metric value is denoted by Wᵢ^{tr†}(t)

7. The method for performing dynamic computing network control of claim 1, wherein the determining at least one of the potential RXs which will retain information associated with the transmitted optimal commodity is based on choosing the RX with largest positive weight W^{(d,m)}^{ₜᵣ}^{^{†}}ᵢⱼ(t).

8. The method for performing dynamic computing network control of claim 1, further comprising:
performing local processing decisions, comprising:
computing, for each commodity (d, m), processing utility weights;
computing an optimal number of allocation resource units and an optimal commodity to process; and determining flow rate assignment decisions.

9. The method for performing dynamic computing network control of claim 7, wherein the processing utility weights are computed by:
$${W}_{i}^{( d , m )} ( t ) {=}^{Δ} {\frac{1}{{r}^{( m + 1 )}} [ {Q}_{i}^{( d , m )} ( t ) - {ξ}^{( m + 1 )} {Q}_{i}^{( d , m + 1 )} ( t ) ]}^{+} .$$

10. The method for performing dynamic computing network control of claim 7, wherein the optimal number of allocated processing resource units and the optimal commodity to process is computed by:
$$[ {k}_{tr}^{†} , {( d , m )}_{pr}^{†} ] = arg {max}_{k , ( d , m )} \{ {R}_{i , k} {W}_{i}^{( d , m )} ( t ) - {Vw}_{i , k}^{pr} \} .$$

11. The method for performing dynamic computing network control of claim 7, wherein the flow rate assignment decisions are determined by:
$${μ}_{i , pr}^{{( d , m )}_{pr}^{†}} ( t ) = {R}_{i , {k}_{pr}^{†}} {r}^{( {m}_{pr}^{†} + 1 )} ;$$

12. A non-transitory machine-readable storage medium encoded with instructions executable to perform a method by a processor for performing dynamic computing network control where at each timeslot t, each node i is configured to observe a set of local queue backlogs, where the local queue backlogs indicate the packet build-up of each commodity at node i and at its potential RXs, the machine-readable storage medium comprising:
instructions for performing local transmission decisions, comprising:
computing, for each of commodity (d, m) and each receiving node j, a differential backlog weight, where d is a destination, m is a function, and j is an integer index indicating a specific receiving node;
computing, for each transmission resource allocation choice, a metric value for each commodity;
computing an optimal number of allocation resource units to allocate and an optimal commodity to transmit; and
transmitting the optimal commodity by allocating the allocation resource units when the metric value is greater than 0.
determining at least one of the potential RXs which will retain information associated with the transmitted optimal commodity.

13. The non-transitory machine-readable storage medium of claim 11, further comprising:
keeping silent when the metric value is less than 0.

14. The non-transitory machine-readable storage medium of claim 11, wherein the differential backlog weight, Wᵢⱼ^{(d,m)}(t) is calculated by:
Wᵢⱼ^{(d,m)}(t) [symbol] [Qᵢ^{(d,m)}(t)−Qⱼ^{(d,m)}(t)]⁺.

15. The non-transitory machine-readable storage medium of claim 11, wherein the metric for each commodity is calculated by:
$${W}_{i , k , tr}^{( d , m )} ( t ) {=}^{Δ} {\sum }_{s ∈ S} Pr ( S ( t ) = s \vert S ( t - 1 ) = \tilde{s} ) \times {\sum }_{n = 1}^{N - 1} [ {R}_{{ig}_{i , n} , k} ( s ) - {R}_{{ig}_{i , n - 1} , k} ( s ) ] {max}_{j ∈ {Ω}_{i , n} ( s )} \{ {W}_{ij}^{( d , m )} ( t ) \} ,$$
wherein \tilde{s} denotes CSI feedback at time t−1 and Ω_{i,n}(s) indicates the dependence of Ω_{i,n} on network state s.

16. The non-transitory machine-readable storage medium of claim 11, wherein the optimal number of resource units, kₜᵣ^{†} to allocate and an optimal commodity, (d, m)ₜᵣ^{†} to transmit are calculated by:
$$[ {k}_{tr}^{†} , {( d , m )}_{tr}^{†} ] = arg {max}_{k , ( d , m )} \{ {W}_{i , k , tr}^{( d , m )} ( t ) - {Vw}_{i , k}^{tr} \} .$$

17. The non-transitory machine-readable storage medium of claim 11, wherein the metric value is denoted by Wᵢ^{tr†}(t).

18. The non-transitory machine reachable storage medium of claim 11, wherein the determining at least one of the potential RXs which will retain information associated with the transmitted optimal commodity is based on choosing the RX with largest positive weight W^{(d,m)}^{ₜᵣ}^{^{†}}ᵢⱼ(t).

19. The non-transitory machine-readable storage medium of claim 11, further comprising:
performing local processing decisions, comprising:
computing, for each commodity (d, m), processing utility weights;
computing an optimal number of allocation resource units and an optimal commodity to process; and
determining flow rate assignment decisions.

20. The non-transitory machine-readable storage medium of claim 17, wherein the processing utility weights are computed by:
$${W}_{i}^{( d , m )} ( t ) {=}^{Δ} {\frac{1}{{r}^{( m + 1 )}} [ {Q}_{i}^{( d , m )} ( t ) - {ξ}^{( m + 1 )} {Q}_{i}^{( d , m + 1 )} ( t ) ]}^{+} .$$

21. The non-transitory machine-readable storage medium of claim 17, wherein the optimal number of allocation resource units and the optimal commodity to process is computed by:
$$[ {k}_{pr}^{†} , {( d , m )}_{pr}^{†} ] = arg {max}_{k , ( d , m )} \{ {R}_{i , k} {W}_{i}^{( d , m )} ( t ) - {Vw}_{i , k}^{pr} \} .$$

22. The non-transitory machine-readable storage medium of claim 11, wherein the flow rate assignment decisions are determined by:
$${μ}_{i , pr}^{{( d , m )}_{pr}^{†}} ( t ) = {R}_{i , {k}_{pr}^{†}} {r}^{( {m}_{pr}^{†} + 1 )} ;$$
$${μ}_{i , pr}^{( d , m )} ( t ) = 0 , ∀ ( d , m ) \neq {( d , m )}_{pr}^{†} .$$
